(19) United States
(12) Patent Application Publication
(10) Pub. No.: US 2023/0145964 A1
(43) Pub. Date: May 11, 2023

(54) MAGNETO-INDUCTIVE POSITION SENSOR ASSEMBLIES

(71) Applicant: KSR IP Holdings, LLC, Wilmington, DE (US)

(72) Inventor: Lingmin Shao, London (CA)

(73) Assignee: KSR IP Holdings, LLC, Wilmington, DE (US)

(21) Appl. No.: 17/984,697

(22) Filed: Nov. 10, 2022

Related U.S. Application Data
(60) Provisional application No. 63/278,251, filed on Nov. 11, 2021.

(51) Int. Cl. G01D 5/20

(52) U.S. Cl. CPC G01D 5/20

(57) ABSTRACT

In accordance with one embodiment of the present disclosure, an inductive sensor assembly is provided. The inductive sensor assembly includes a housing formed of a magnetic plastic material and a sensor assembly having a transmitter coil and a receiving coil. The housing encapsulates the transmitter coil and the receiving coil. A movable target having a magnetic material is spaced apart from the housing and is configured to move along a predetermined trajectory relative to the housing. When the target is moved along the predetermined trajectory, the movement causes an area of low permeability in regions of the housing that is sensed by the receiving coil to determine the location of the target with respect to the housing.

### CROSS REFERENCE TO RELATED APPLICATIONS

This utility patent application claims priority from U.S. Provisional Patent Application Ser. No. 63/278,251, filed on Nov. 11, 2021, entitled “Magneto-Inductive Position Sensor Assemblies”, the entire contents of which is incorporated herein in its entirety.

### TECHNICAL FIELD

The present specification generally relates to inductive position sensor assemblies and, more particularly, to inductive position sensor assemblies for multiple trajectories of a target.

### BACKGROUND

It is known to provide, in automotive applications, inductive angular position sensors printed on a printed circuit board (“PCB”). An inductive position sensor includes a transmitter coil powered by an alternating current source to produce an electromagnetic carrier flux. A receiver coil receives the carrier flux, and generates a receiver signal. The receiver signal varies with the position of a coupler element (such as a rotor) supported parallel to and closely adjacent to the transmitter coil and receiver coil. As such, the coupler element couples the coils to create eddy currents in the receiving coil. When the coupler elements move, the magnitude of the eddy currents changes in proportion to the position of the coupler element. However, coupler elements are a disadvantage in that they cannot be used through conductive materials such as aluminum. Presently known inductive sensors require a layer of ferrite to be used as an insulator in applications where the target is housed in aluminum.

### SUMMARY

In one embodiment, an inductive sensor assembly is provided. The inductive sensor assembly includes a housing formed of a magnetic plastic material and a sensor assembly having a transmitter coil and a receiving coil. The housing encapsulates the transmitter coil and the receiving coil. A movable target having a magnetic material is spaced apart from the housing and is configured to move along a predetermined trajectory relative to the housing. When the target is moved along the predetermined trajectory, the movement causes an area of low permeability in regions of the housing that is sensed by the receiving coil to determine the location of the target with respect to the housing.

In another embodiment, an inductive sensor assembly is provided. The inductive sensor assembly includes a housing, a sensor assembly, and a movable target. The housing is formed of a magnetic plastic material. The sensor assembly includes a circuit board that includes a transmitter coil having an outer diameter and a receiving coil positioned within the outer diameter of the transmitter coil. The housing encapsulates the circuit board, the transmitter coil and the receiving coil. The movable target is formed at least partially from a magnetic material and is spaced apart from the housing. The movable target is configured to move along a predetermined trajectory relative to the housing. When the target is moved along the predetermined trajectory, the movement causes an area of low permeability in regions of the housing that is sensed by the receiving coil to determine the location of the target with respect to the housing.

In yet another embodiment, an inductive sensor assembly is provided. The inductive sensor assembly includes a housing, a sensor assembly, and a movable target. The housing is formed of a magnetic plastic material. The sensor assembly includes a flexible circuit board having a transmitter coil having an outer diameter and a two-part receiving coil positioned within the outer diameter of the transmitter coil. The housing encapsulates the flexible circuit board, the transmitter coil and the receiving coil. The movable target is formed at least partially from a magnetic material and is spaced apart from the housing. The movable target is configured to move along a predetermined trajectory relative to the housing. The circuit board and the housing are shaped similar to the predetermined trajectory of the movable target. When the target is moved along the predetermined trajectory, the movement causes an area of low permeability in regions of the housing that is sensed by the two-part receiving coil to determine the location of the target with respect to the housing.

These and additional features provided by the embodiments described herein will be more fully understood in view of the following detailed description, in conjunction with the drawings.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 schematically depicts a perspective view of a first aspect of inductive sensing assembly according to one or more embodiments shown and described herein;

FIG. 2 schematically depicts a perspective view of a second aspect of inductive sensing assembly according to one or more embodiments shown and described herein;

FIG. 3 schematically depicts a cross-sectional view of the inductive sensing assembly of FIG. 2 taken from line 3-3 according to one or more embodiments shown and described herein;

FIG. 4 schematically depicts a perspective view of a third aspect of inductive sensing assembly according to one or more embodiments shown and described herein;

FIG. 5 schematically depicts a cross-sectional view of the inductive sensing assembly of FIG. 4 taken from line 5-5 according to one or more embodiments shown and described herein;

FIG. 6 schematically depicts a perspective view of a fourth aspect of inductive sensing assembly according to one or more embodiments shown and described herein; and

FIG. 7 graphically illustrates a sensor output of the inductive sensing assembly according to one or more embodiments shown and described herein.

### DETAILED DESCRIPTION

Embodiments described herein are directed to an inductive position sensor assembly. The assembly includes a housing, a transmitter coil, a two-part receiving coil, a flexible circuit board included in a printed wiring assembly, and a movable target. The transmitter coil includes an outer diameter or perimeter based on the shape of the transmitter coil. The two-part receiving coil is generally positioned within the outer diameter or perimeter of the transmitter coil. The housing encapsulates the transmitter coil, the two-part receiving coil, and the flexible circuit board included in the printed wiring assembly. The housing is made from a magnetic plastic that works in conjunction with a magnet of the movable target, which causes an area of low permeability in regions of the housing. The area of the low permeability forms a “virtual coupler” which may be detected or sensed by the two-part receiving coil. As such, the “virtual coupler” permits a resonator to excite the transmitter coil to generate eddy currents in the two-part receiving coil in the same fashion as traditional inductive sensors, but without an insulator layer, such as a ferrite layer or other magnetic metal, metal alloys, mu-metals, or metal. Further, the housing may be manipulated into a plurality of shapes to match or correspond to a non-linear trajectory of the movable target.

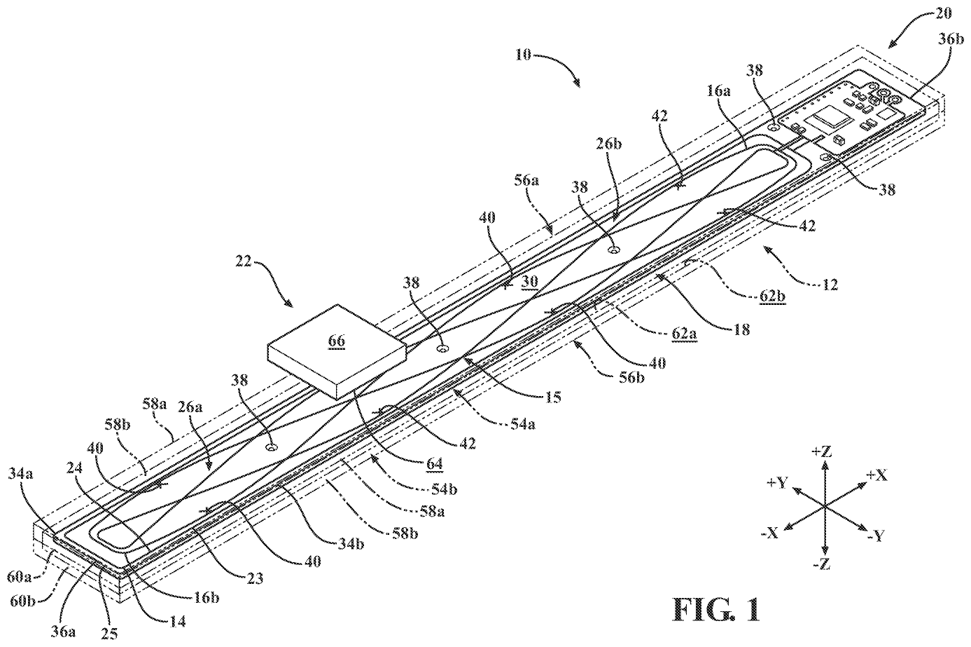

As used herein, the term “longitudinal direction” refers to the forward-rearward direction of the assembly (i.e., in the +/−X-direction depicted in FIG. 1). The term “lateral direction” refers to the cross-assembly direction (i.e., in the +/−Y-direction depicted in FIG. 1), and is transverse to the longitudinal direction. The term “vertical direction” or “up” or “above” refer to the upward-downward direction of the assembly (i.e., in the +/−Z-direction depicted in FIG. 1).

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

Referring initially to FIGS. 1-6, an inductive sensing assembly 10 is schematically depicted. The inductive sensing assembly 10 includes a housing 12, a transmitter coil 14, a two-part receiving coil 15, a flexible circuit board 18 included in a printed wiring assembly 20, and a movable target 22. The flexible circuit board 18 includes an exterior surface 30 and an opposite interior surface 32 and a plurality of layers positioned therebetween to define a thickness. Further, the flexible circuit board 18 includes a pair of sidewall edges 34a, 34b spaced apart from one another and a pair of end edges 36a, 36b spaced apart from one another. The flexible circuit board 18 may be a planar board on which interconnected circuits and components are laminated or etched. Further, the flexible circuit board 18 may be a board that may bend or flex, and may be made from a flexible film. Further, in some embodiments, the flexible circuit board 18 may be a multi-layer flex circuit board. In other embodiments, the flexible circuit board 18 may be a single-sided flexible circuit board, a double-sided flexible circuit board, a rigid-flex circuit board, and/or the like.

A plurality of openings 38 may extend through the flexible circuit board 18 and the housing 12 to couple to flexible circuit board 18 and the housing 12 via fasteners. Example fasteners include rivets, bolt and nuts, screws, and/or the like. Other example fasteners may include weld, epoxy, adhesive, hook and loop, and the like.

The housing 12 encapsulates or encloses the flexible circuit board 18. That is, the housing 12 encloses or encapsulates the interior surface 32, the exterior surface 30, the pair of sidewall edges 34a, 34b, and the pair of end wall edges 36a, 36b of the flexible circuit board 18. In some embodiments, the housing 12 may include a first portion 54a or half and a second portion 54b or half. In some embodiments, each of the first portion 54a and the second portion 54b may include a receiving cavity 56a, 56b defined by a pair of sidewalls 58a, 58b and a pair of end walls 60a, 60b, with an inner surface 62a, 62b, respectively. As such, in this embodiment, as best illustrated in FIGS. 1-2 and 6, the flexible circuit board 18 is received in the receiving cavity 56a, 56b and encapsulate the flexible circuit board 18 when the pair of sidewalls 58a and the pair of end walls 60a of the first portion 54a make contact or abut the pair of sidewalls 58b and the pair of end walls 60b of the second portion 54b.

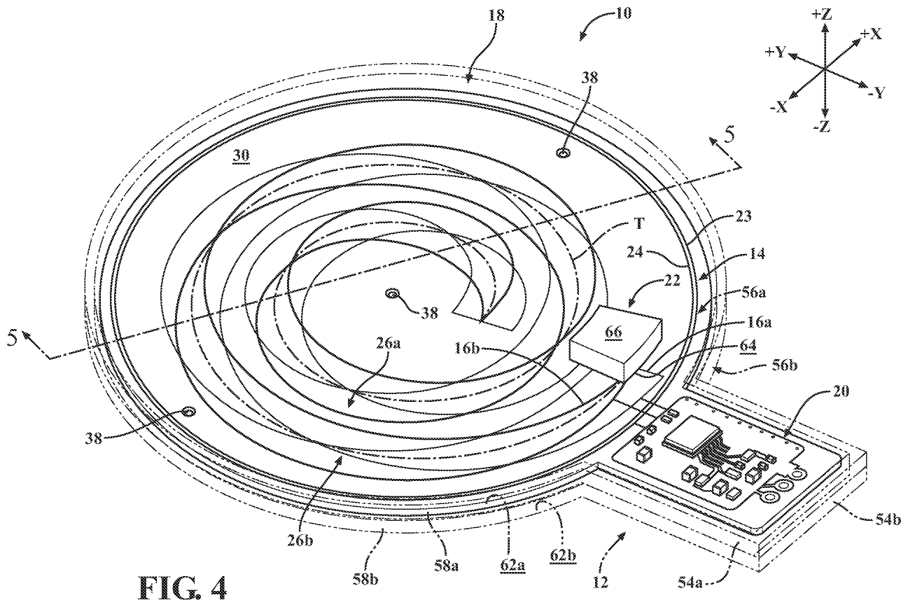

In other embodiments, such as the illustrated embodiment schematically depicted in FIG. 4, the pair of sidewalls 58a, 58b are continuously arcuate or curved with a radius to surround or encapsulate the flexible circuit board 18. As such, because the flexible circuit board 18 is circular in shape, there is not an end wall in the same manner as end walls are described herein with respect to a rectangular or half-moon shape.

Each of the first portion 54a and the second portion 54b may be manufactured using injection molding methods, additive manufacturing methods, and/or other manufacturing methods. As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components.

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Digital Light Processing (DLP), Direct Selective Laser Melting (DSLM), Selective Laser Melting (SLM), Direct Metal Laser Melting (DMLM), and other known processes.

In other embodiments, the housing 12 may be a single monolithic structure that includes the receiving cavity that receives the flexible circuit board, as described above. The housing 12 may be manufactured using injection molding methods, additive manufacturing methods, and/or other manufacturing methods.

Further, the housing 12 may be made of soft magnetic plastic. In some embodiments, the magnetic plastic of the housing 12 has a permeability greater than 10. In other embodiments, the magnetic plastic of the housing 12 has a permeability equal to or less than 10. In some embodiments, the soft magnetic plastics may be soft magnetic composites (SMC) with iron-based powders that are insulated and pressed to realize shapes otherwise impossible with the traditional lamination sheets technology. For example, the soft magnetic plastics of the housing 12 may use SMC mixing iron powders and phenolic resin, in different weight percentages and mold pressures, to form different housing shapes and/or a flexible housing (e.g., monolithic and/or the first portion 54a and the second portion 54b) that correspond to different trajectories of the movable target 22, as discussed in greater detail herein.

As such, the housing 12 may be composed of metallic soft magnetic material and insulating medium that combine the advantages of metallic soft magnetic materials and soft ferrite materials such that the resistivity is significantly higher than metallic soft magnetic materials and may decrease the eddy current effectively while providing a higher saturation magnetic induction in comparison to conventional systems that use soft ferrite materials.

In other embodiments, the housing 12 may be composed of metallic soft magnetic materials that include pure iron, silicon steel, and permalloy such as, without limitation, Ni—Fe alloy. Silicon steel may be rolled to sheet and laminated to reduce eddy current loss. Magnetism of metallic soft magnetic material originate from ferromagnetic metals and alloys such that the resistivity is low, there is a greater permeability, saturation magnetic induction, and Curie Temperature, and may be beneficial to be applied in lower frequency domain.

In other embodiments, the housing 12 may be composed of amorphous soft magnetic materials. Nanocrystalline soft magnetic material is a type of soft magnetic alloy, which may be manufactured by casting a molten metal into solid ribbons and then rapidly cooling it to prepare a uniform and very fine nanocrystalline microstructure. Amorphous and nanocrystalline soft magnetic materials are known for improved permeability, saturation magnetic induction, core loss, Curie Temperature, and resistivity and may be beneficial to be applied in higher frequency domain.

For example, referring back to FIG. 1, in one embodiment, the housing 12 may take on a linear shape to correspond to a linear trajectory of the movable target 22. In a non-limiting example, a specific application of the inductive sensing assembly 10 in this configuration may be for use in determining the position of a shock absorber that moves linearly with respect to the soft magnetic plastic housing.

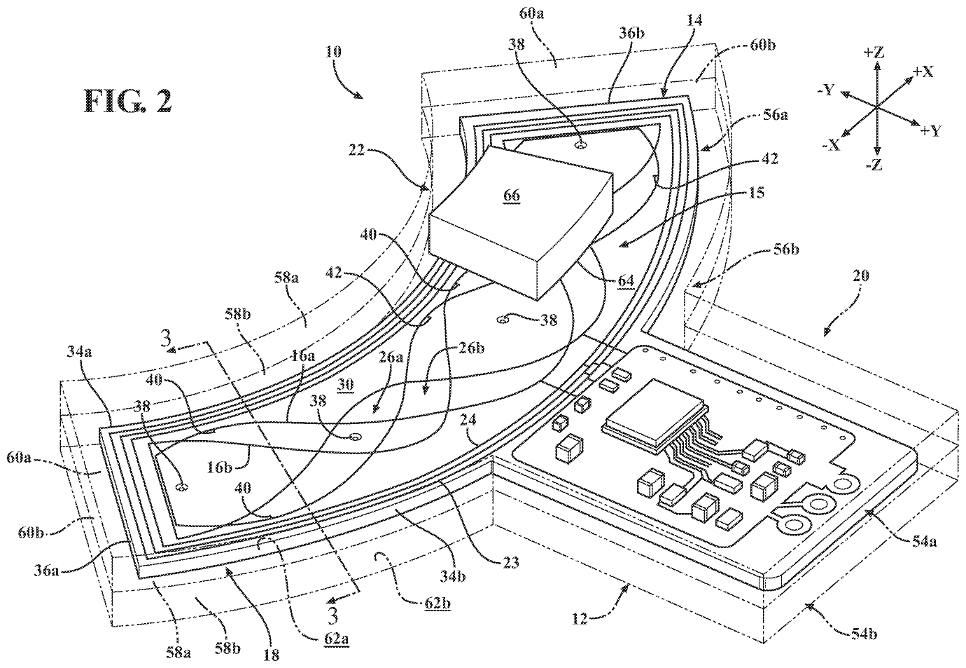

In another embodiment, referring now to FIG. 2, the housing 12 may take on an arcuate or curvilinear shape that corresponds to an arcuate or curvilinear trajectory of the movable target 22. In a non-limiting example, a specific application of the inductive sensing assembly 10 in this configuration may be for use in determining the position of the movable target 22 that moves in an angular or circular trajectory such as a shaft or other elongated member.

In another embodiment, referring now to FIG. 4, the housing 12 may take on a spirograph shape that corresponds to a spirograph trajectory of the movable target 22, depicted as a dashed-dot line and with the reference character “T” in FIG. 4. In a non-limiting example, a specific application of the inductive sensing assembly 10 in this configuration may be an arcuate or curvilinear movement along a spiral trajectory in a single plane such as those commonly found in arithmetic spirals, such as in multi-turn angle sensor applications.

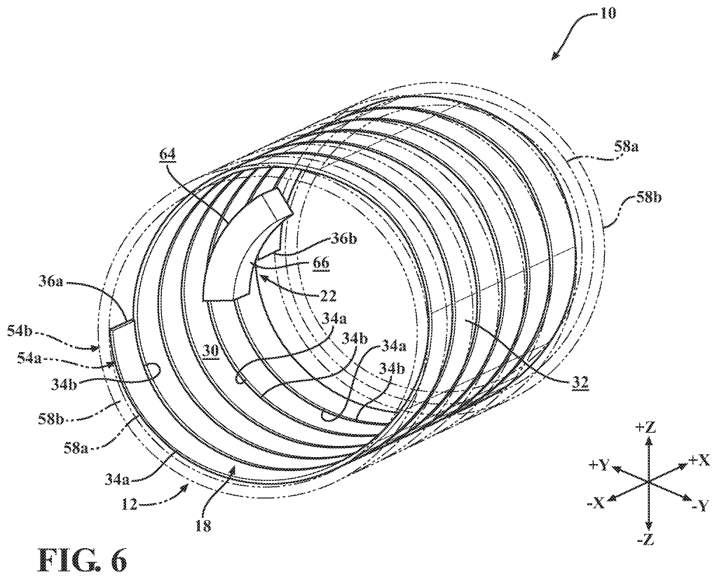

In another embodiment, referring now to FIG. 6, the housing 12 may be similar to the shape in FIG. 1 discussed above, but the inductive sensing assembly 10 is curled into a helix shape to correspond to a helix trajectory of the movable target 22. That is, the housing 12 extends in a continuously curled linear shape to form the helix shape to correspond to a helix trajectory of the movable target 22. In a non-limiting example, a specific application of the inductive sensing assembly 10 in this configuration may be for use in multi-turn angle sensor applications and/or lead screw sensing.

It should be understood that the trajectories and the various corresponding shapes of the housing 12 provided in the examples provided in FIGS. 1-2, 4 and 6 are non-limiting and other shapes and trajectories are envisioned. For example, the trajectory may be angular, include linear and arcuate trajectories, include linear and spirograph trajectories, and the like. As such, the housing 12, the flexible circuit board 18, the transmitter coil 14 and the two-part receiving coil 15 take on many shapes to correspond to the trajectory of the movable target 22.

Referring back to FIGS. 1-6, the transmitter coil 14 includes an outer diameter or perimeter 23 and an opposite inner diameter 24. The outer diameter or perimeter 23 and/or the inner diameter 24 may be based on the shape or trajectory of the movable target 22. For example, when the trajectory of the movable target 22 is linear, the shape of the outer diameter or perimeter 23 and/or the inner diameter 24 of the transmitter coil 14 may be linear such as rectangular, square, and the like, as best depicted in FIG. 1. That this, the flexible circuit board 18 and the transmitter coil 14, as depicted in FIG. 1, are each generally a rectangular shape and the transmitter coil 14 extends near a terminating perimeter 25 of the flexible circuit board 18 to surround the first receiving coil 16a and the second receiving coil 16b.

In another non-limiting example, when the trajectory of the movable target 22 is arcuate or curvilinear, the shape of the outer diameter or perimeter 23 and/or the inner diameter 24 of the transmitter coil 14 may be arcuate or curvilinear, such as an isosceles trapezoid shape schematically depicted in FIG. 2. This is non-limiting, and the transmitter coil 14 may be a half-moon shape, a trapezoid shape, a parallelogram shape, a crescent moon shape, and the like.

In another non-limiting example, when the trajectory of the movable target 22 is in a spirograph movement, as depicted by the dashed-dot-dashed line of FIG. 4, the shape of the transmitter coil 14 and correspondingly the outer diameter or perimeter 23 and/or the inner diameter 24 of the transmitter coil 14 may be circular. This is non-limiting and the transmitter coil 14 may be any shape such as a kite shape, a rectangle, a square, a rhombus, and the like. In another non-limiting example, when the trajectory of the movable target 22 is in a helix movement, as best illustrated in FIG. 6, the shape of the outer diameter or perimeter 23 and/or the inner diameter 24 of the transmitter coil 14 may be similar to the linear arrangement, as best depicted in FIG. 1.

The transmitter coil 14 may be one or more loops shaped as described herein. The transmitter coil 14, which may also be referred to as an exciter coil, may be powered by an alternating current source, such as the alternating current source positioned within or communicatively coupled to the printed wiring assembly 20. When excited by electrical energy, the transmitter coil 14 radiates electromagnetic radiation. There is inductive coupling between the transmitter coil 14 and any other proximate coils, which induces a signal in that coil. Inductive coupling between the transmitter coil 14 and two-part receiving coil 15 generates a receiver signal in each respective coil.

For example, the term ‘receiver signal’ may be used generally to refer to signals induced in the two-part receiving coil 15, and also to any conditioned signal based on the signals induced in the two-part receiving coil 15. In examples discussed below, a single receiver signal is provided by the two-part receiving coil 15 that includes contributions from, for example, a first receiving coil 16a and a second receiving coil 16b configurations of the two-part receiving coil 15. That is, the first receiving coil 16a and the second receiving coil 16b provide first and second signals, respectively. The receiver signal is then some combination of the first and second signals.

For example, the first receiving coil 16a and the second receiving coil 16b configurations may be configured to generate signals that are of opposite phase, the receiver signal being the combination of the first and second signals, and hence the receiver signal has a minimum value when the first and second signals have similar magnitudes. The receiver signal may also be termed a difference signal, as the magnitude of the receiver signal is a difference between a first signal amplitude induced in the first receiving coil 16a, and a second signal amplitude induced in the second receiving coil 16b.

In other examples of the present invention, the two-part receiving coil 15 may provide separate first and second signals from separate loop structures to an electronic circuit for processing such as the printed wiring assembly 20. It should be understood that the two-part receiving coil 15 may be a three-part, a four-part, a five-part and so one, with each one adding an additional receiving coil and an additional receiver signal generated by the receiving coil, respectively.

The first receiving coil 16a and the second receiving coil 16b configurations of the two-part receiving coil 15 may be configured to provide first and second voltages of opposite polarity for a given magnetic flux change through the two-part receiving coil 15. The two-part receiving coil 15 may be configured so that the first and second signals tend to cancel each other in the absence of the movable target 22. The movable target 22 also may have a zero position in which it blocks flux transmission to first receiving coil 16a and the second receiving coil 16b equally, such that the first signal and second signal effectively cancel each other out.

That is, in other embodiments, as the movable target 22 moves in a first direction relative to the initial position, it blocks more magnetic flux inducing the second signal, while at the same time blocking less magnetic flux that induces the first signal. Hence, the magnitude of the first signal increases, the magnitude of the second signal decreases, and the receiver signal increases in magnitude. The movable target 22 may also be moveable in a second direction, in which the magnitude of the second signal increases, and that of the first signal decreases.

The first receiving coil 16a and the second receiving coil 16b may each include a plurality of loops 26a, 26b respectively. In some embodiments, each of the plurality of loops 26a, 26b are coils, traces, and the like. Each of the plurality of loops 26a of the first receiving coil 16a may be on a different layer of the flexible circuit board 18 than the plurality of loops 26b of the second receiving coil 16b in an axial direction or vertical direction (i.e., in the +/−Z-direction), as described in further detail herein. In some embodiments, each of the plurality of loops 26a, 26b are symmetrical in shape and transverse the flexible circuit board 18 in a uniform manner such that the plurality of loops 26a of the first receiving coil 16a mirror the plurality of loops 26b of the second receiving coil 16b are mirror images of one another. That is, each of the plurality of loops 26a of the first receiving coil 16a may have a continuous or constant change in direction that is mirrored by the plurality of loops 26b of the second receiving coil 16b, only positioned to be inverse of one another.

For example, with reference to FIGS. 1-2, the plurality of loops 26a of the first receiving coil 16a extend beyond an outermost portion of the plurality of loops 26b of the second receiving coil 16b at the end wall edge 36b while the inverse occurs at the end wall edge 36a where the plurality of loops 26b of the second receiving coil 16b extend beyond an outermost portion of the plurality of loops 26a of the first receiving coil 16a. Similarly, each of the plurality of loops 26a of the first receiving coil 16a extend beyond portions of the plurality of loops 26b of the second receiving coil 16b at various positions along the pair of sidewall edges 34a, 34b. Further, at the positions where the plurality of loops 26a of the first receiving coil 16a do not extend beyond portions of the plurality of loops 26b of the second receiving coil 16b, the inverse occurs. That is, at these positions, the plurality of loops 26b of the second receiving coil 16b extend beyond portions of the plurality of loops 26a of the first receiving coil 16a. In other embodiments, each of the plurality of loops 26b of the second receiving coil 16b and the plurality of loops 26a of the first receiving coil 16a are not symmetric, irregular, and/or are not inverse of one another.

Referring now to FIGS. 4-5, the plurality of loops 26a of the first receiving coil 16a alternative extending beyond an outermost portion of the plurality of loops 26b of the second receiving coil 16b at the 3:00 o'clock, 6:00 o'clock, 9:00 o'clock and 12:00 o'clock positions. As such, portions of each of the plurality of loops 26a of the first receiving coil 16a extend beyond portions of the plurality of loops 26b of the second receiving coil 16b at various positions along the spirogragh arrangement and, vice versa, portions of the plurality of loops 26b of the second receiving coil 16b extend beyond portions of the plurality of loops 26a of the first receiving coil 16a. As such, the plurality of loops 26a of the first receiving coil 16a and the plurality of loops 26b of the second receiving coil 16b are each independently arranged in a spirograph arrangement and may be offset form one another.

Now referring back to FIGS. 1-6, it should be appreciated that the depth of the plurality of loops 26b of the second receiving coil 16b and the plurality of loops 26a of the first receiving coil 16a are selected with a relationship to the trajectory of the movable target 22 based on a strength of the signal required for the airgap or distance. That is, each one of the plurality of loops 26b of the second receiving coil 16b is in one layer of the flexible circuit board 18 and each one of the plurality of loops 26a of the first receiving coil 16a are in another or different layer of the flexible circuit board 18. As such, the airgap may vary based on the application of use, the trajectory of the movable target 22, the size and shape of the coils, and the position of the coils within the flexible circuit board 18. In a non-limiting example, the airgap may be between 2 millimeters and 10 millimeters. This is a mere example and the airgap may be less than 2 millimeters or greater than 10 millimeters.

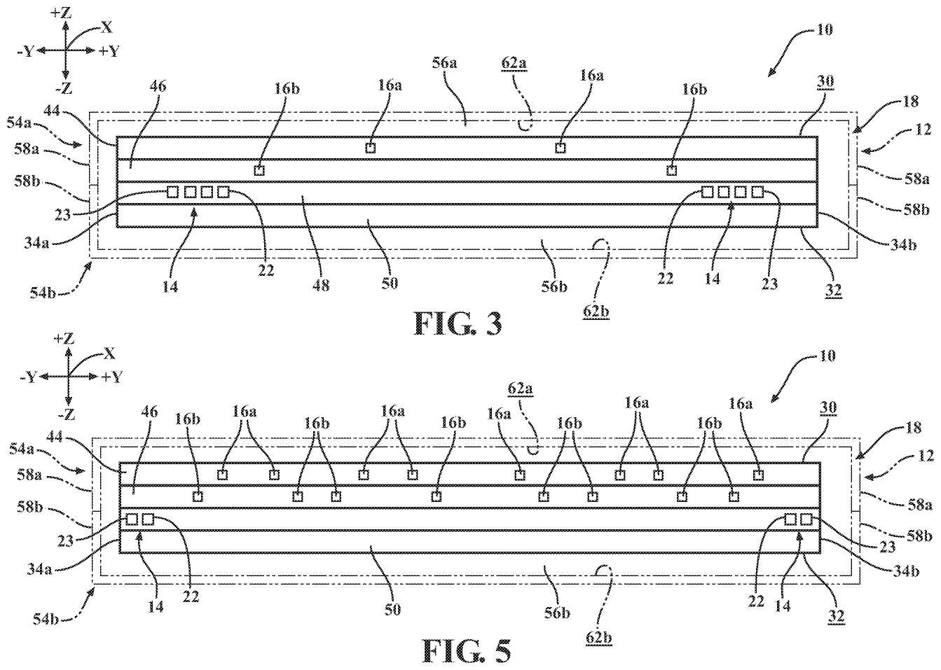

In some embodiments, the first receiving coil 16a and the second receiving coil 16b may be positioned in adjacent or adjoining layers. In other embodiments, the first receiving coil 16a and the second receiving coil 16b may be positioned in layers that are spaced apart or separated by another layer that may be unoccupied or may contain other coils (i.e. a portion of the transmitter coil and the like). As such, when there is an overlap or underlap of portions of the plurality of loops 26b of the second receiving coil 16b with the plurality of loops 26a of the first receiving coil 16a occurs on different layers of the flexible circuit board 18 in an axial direction or vertical direction (i.e., in the +/−Z direction), as best illustrated in FIGS. 3 and 5.

In some embodiments, the overlap/underlap may occur at a position inside of or within outermost portions of each of the plurality of loops 26b of the second receiving coil 16b and outer most portions of the plurality of loops 26a of the first receiving coil 16a in the lateral direction (i.e., in the +/−Y direction). That is, in these embodiments, each of the overlapping/underlapping portions may occur are closer to a central portion of the flexible circuit board 18 than the outermost portions of each of the plurality of loops 26b of the second receiving coil 16b and outer most portions of the plurality of loops 26a of the first receiving coil 16a, which may be closer to one of the pair of sidewall edges 34a, 34b in the lateral direction (i.e., in the +/−Y direction) and/or closer to one of the pair of end wall edges 36a, 36b in the longitudinal direction (i.e., in the +/−X direction). In other embodiments, the overlapping/underlapping portions may occur at the outermost portions of the respective coil of the two-part receiving coil 15.

Referring back to FIGS. 1-2, connection junctions 40 may be disposed throughout the plurality of loops 26a of the first receiving coil 16a and connection junctions 42 may be disposed throughout the plurality of loops 26b of the second receiving coil 16b. It should be appreciated that the number of connection junctions 40, 42 may depend on the number of coils, and, as such, embodiments described herein are non-limiting examples thereof. The connection junctions 40 occur when portions of the plurality of loops 26a of the first receiving coil 16a alternate or change between layers of the flexible circuit board 18 such that each of the plurality of loops 26a of the first receiving coil 16a are communicatively coupled to one another. As such, the connection junctions 40 extend between layers of the flexible circuit board 18 in the vertical direction (i.e., in the +/−Z direction) to connect different portions of the of the plurality of loops 26a of the first receiving coil 16a positioned on different layers of the flexible circuit board 18.

Further, the connection junctions 42 occur when portions of the plurality of loops 26a of the first receiving coil 16a alternate or change between layers of the flexible circuit board 18 such that each of the plurality of loops 26a of the first receiving coil 16a are communicatively coupled to one another. As such, the connection junctions 42 extend between layers of the flexible circuit board 18 in the vertical direction (i.e., in the +/−Z direction) to connect different portions of the of the plurality of loops 26b of the second receiving coil 16b positioned on different layers of the flexible circuit board 18.

As such, it should be appreciated that the overlap portions are not connected with the path of the coil above and/or below except at the connection junctions 40, 42, and that this coil arrangement permits sensing of the movable target 22 along the trajectory from different distances or air gaps and permits the first receiving coil 16a and the second receiving coil 16b to act as independent coils. In yet other embodiments, portions of the first receiving coil 16a and the second receiving coil 16b are disposed within the same layer of the flexible circuit board 18 to have the same depth in the vertical direction (i.e., in the +/−Z-direction) or airgap from the movable target 22.

Referring now to FIGS. 3 and 5, a cross-sectional view of the inductive sensing assembly 10 of FIG. 1 taken from line 2-2 and a cross-sectional view of the inductive sensing assembly 10 of FIG. 4 taken from line 5-5 will be described. As discussed above, the first receiving coil 16a may be disposed within a particular layer or set of layers of the flexible circuit board 18 while the second receiving coil 16b may be disposed within another particular layer or set of layers of the flexible circuit board 18. In addition, the transmitter coil 14 may be disposed within a particular layer or set of layers of the flexible circuit board 18. For example and not a limitation, the first receiving coil 16a is positioned in a first layer 44 and the second receiving coil 16b are positioned in a second layer 46 such that each occupy separate layers of the flexible circuit board 18, as discussed in greater detail above.

Further, transmitter coil 14 is illustrated as being positioned in a third layer 48 and a fourth layer 50 is left vacant, or unoccupied, such that each occupy separate layers of the flexible circuit board 18. It should be appreciated that is merely an example and is not a limit of the transmitter coil 14 or the two-part receiving coil 15 as discussed and described herein. As such, it should also be appreciated that each layer of the flexible circuit board 18 may have a different coil. Further, it should be appreciated that the two-part receiving coil 15 may be positioned above or below the transmitter coil 14 in the axial or vertical direction (i.e., in the +/−Z-direction). It should also be appreciated that the flexible circuit board 18 may have more than, or less than, four layers and that some layers may be unoccupied by a coil or the like.

Now referring back to FIGS. 1-6, the printed wiring assembly 20 may include a plurality of electrical components interconnected with the two-part receiving coil 15 and the transmitter coil 14. The printed wiring assembly 20 may be operable to measure a change in the magnetic field, eddy current, saturation, and/or the like, as discussed in greater detail herein. Chips and other electronic components are mounted on the circuits such the chips and other electronic components are communicatively coupled such that signals may pass between them. For example, the chip may include an application-specific integrated circuit (ASIC) with a processor that controls the printed wiring assembly 20 and may transmit data to one or more of the electrical system or subsystems in an automotive application. The processor may be an electronic control unit (ECU) that may be communicatively coupled to electronic/engine control module (ECM), powertrain control module (PCM), transmission control module (TCM), brake control module (BCM or EBCM), central control module (CCM), central timing module (CTM), general electronic module (GEM), body control module (BCM), suspension control module (SCM), control unit, or control module. As such, it should be appreciated that the embodiments disclosed herein may be applicable to each one of these automotive applications/systems.

In some embodiments, the printed wiring assembly 20 is positioned at one of the pair of end wall edges 36a between the pair of sidewall edges 34a, 34b, as best illustrated in FIG. 1. In other embodiments, the printed wiring assembly 20 is positioned between the pair of end wall edges 36a, 36b and extends from one of the pair of sidewall edges 34a, as best illustrated in FIG. 2. As such, in some embodiments, the printed wiring assembly 20 may be encapsulated or enclosed by the housing 12. In other embodiments, the transmitter coil 14, the two-part receiving coil 15, and the flexible circuit board 18 may be encapsulated or enclosed by the housing 12, while the printed wiring assembly 20 may be open or enclosed by some other housing other than the housing 12.

The movable target 22 may include a coupling surface 64 and an opposite attachment surface 66 to define a thickness. The movable target 22 may be removably coupled or fixedly coupled to any object via the attachment surface 66 or any other surface, such that the movable target 22 acts as a coupler. The movable target 22 may be removably coupled or fixedly coupled via an adhesive, weld, solider, a snap fit, a press lock, a fastener such as a setscrew, and bolt and nut, a screw, a rivet, and the like.

In some embodiments, the movable target 22 may be magnet. In other embodiments, the movable target 22 may have a magnetic layer positioned on, extending from, and/or covering, the coupling surface 64. As such, the moveable may be or include a magnetic layer that is a permanent magnet, temporary magnet, electromagnet, and the like. As such, the movable target 22 may be partially formed with a magnet. Further, the movable target 22 may be a ceramic material, a ferrite material, Alnico magnets, and/or other material such as SmCo or NdFe magnet and the like. Further, the movable target 22 may be a bar magnet, a rod magnet, a plate magnet and the like.

As such, the magnetization direction could be axial or diametrical. As such, it should be appreciated that the magnet shape and material is flexible. Further, it should be appreciated that in embodiments, the movable target 22 produces a magnetic field that is influenced by the movable target 22. In some embodiments, the magnetic field is transverse, or perpendicular to the axis of movement. In other embodiments, the magnetic field is parallel to the axis of movement. In other embodiments, the magnetic field extends from the movable target 22 in the vertical direction (i.e., in the +/−Z direction).

The housing 12 works in conjunction with the magnet of the movable target 22, which causes an area of low permeability in regions of the housing 12 based on the position of the movable target 22. The area of the low permeability forms a “virtual coupler” which may be detected or sensed by the two-part receiving coil. As such, the “virtual coupler” when the transmitter coil 14 is excited and generates eddy currents in the two-part receiving coil 15, the two-part receiving coil 15 may detect or sense the areas of the low permeability. That is, the magnetic flux of the housing is altered or changed by the movable target 22, which is detected or sensed by the two-part receiving coil 15 without the need to use ferrite based metals, mu-metals, alloys, and the like, found in conventional systems. Further, the housing 12 includes the flexibility to be used in any trajectory of movement of the movable target 22, which permits for flexibility in applications as well as packaging constraints.

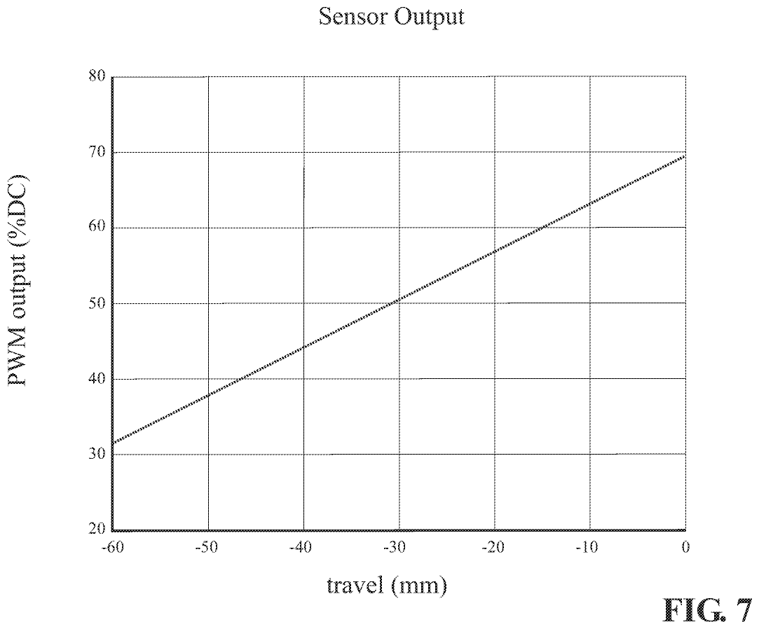

Now referring to FIG. 7, which graphically illustrates a sensor output of the inductive sensing assembly 10. As graphically illustrated, as the travel in millimeters of the movable target 22 with the magnet changes in a linear trajectory, the sensor output, displayed as a PWM output (% DC), increases in a linear trajectory to match the movement of the movable target 22.

The above-described inductive sensor assembly is customizable to a plurality of shapes to accommodate arbitrary trajectories and may be used in applications as an inductive sensor without a ferrite layer. As such, the inductive sensor assembly described herein includes a reduced cost of manufacturing, improved performance, and may be used in wide range of sensing applications compared to conventional inductive sensor assemblies that that traditionally require ferrite or other metal based layers.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An inductive sensor assembly comprising:
a housing formed of a magnetic plastic material;
a sensor assembly having a transmitter coil and a receiving coil,
wherein the housing encapsulates the transmitter coil and the receiving coil; and
a movable target having a magnetic material and is spaced apart from the housing, the movable target is configured to move along a predetermined trajectory relative to the housing,
wherein when the target is moved along the predetermined trajectory, the movement causes an area of low permeability in regions of the housing that is sensed by the receiving coil to determine a location of the target with respect to the housing.

2. The inductive sensor assembly of claim 1, further comprising:
a circuit board,
wherein the transmitter coil and the receiving coil are positioned within the circuit board.

3. The inductive sensor assembly of claim 2, wherein the circuit board in encapsulated by the housing.

4. The inductive sensor assembly of claim 1, wherein the receiving coil is a two-part receiving coil.

5. The inductive sensor assembly of claim 1, wherein the target is formed from the magnetic material.

6. The inductive sensor assembly of claim 1, wherein the transmitter coil has an outer diameter.

7. The inductive sensor assembly of claim 6, wherein the receiving coil is positioned within the outer diameter of the transmitter coil.

8. The inductive sensor assembly of claim 1, wherein:
the predetermined trajectory is a linear trajectory; and
the housing extends in a linear shape to sense the movable target moving along the linear trajectory.

9. The inductive sensor assembly of claim 1, wherein:
the predetermined trajectory is a arcuate trajectory;
the receiving coil is arcuate in shape; and
the housing extends in an arcuate shape to encapsulate the receiving coil and to sense the movable target moving along the arcuate trajectory.

10. The inductive sensor assembly of claim 9, wherein the transmitter coil is an isosceles trapezoid shape.

11. The inductive sensor assembly of claim 1, wherein:
the predetermined trajectory is a spirograph trajectory;
the receiving coil is a spirograph shape; and
the housing is a circular shape to encapsulate the receiving coil and to sense the movable target moving along the spirograph trajectory.

12. The inductive sensor assembly of claim 1, wherein:
the predetermined trajectory is a helix trajectory; and
the housing extends in a continuously curled linear shape to sense the movable target moving along the helix trajectory.

13. An inductive sensor assembly comprising:
a housing formed of a magnetic plastic material;
a sensor assembly having:
a circuit board having:
a transmitter coil having an outer diameter; and
a receiving coil positioned within the outer diameter of the transmitter coil,
wherein the housing encapsulates the circuit board, the transmitter coil and the receiving coil; and
a movable target formed at least partially from a magnetic material and is spaced apart from the housing, the movable target is configured to move along a predetermined trajectory relative to the housing,
wherein when the target is moved along the predetermined trajectory, the movement causes an area of low permeability in regions of the housing that is sensed by the receiving coil to determine a location of the target with respect to the housing.

14. The inductive sensor assembly of claim 13, wherein:
the predetermined trajectory is a linear trajectory; and
the housing extends in a linear shape to sense the movable target moving along the linear trajectory.

15. The inductive sensor assembly of claim 13, wherein:
the predetermined trajectory is an arcuate trajectory;
the circuit board is arcuate in shape; and
the housing extends in an arcuate shape to encapsulate the circuit board and to sense the movable target moving along the arcuate trajectory.

16. The inductive sensor assembly of claim 13, wherein:
the predetermined trajectory is a spirograph trajectory;
the receiving coil is a spirograph arrangement; and
the housing is a circular shape to encapsulate the receiving coil and to sense the movable target moving along the spirograph trajectory.

17. The inductive sensor assembly of claim 13, wherein:
the predetermined trajectory is a helix trajectory; and
the housing extends in a continuously curled linear shape to sense the movable target moving along the helix trajectory.

18. An inductive sensor assembly comprising:
a housing formed of a magnetic plastic material;
a sensor assembly having:
a flexible circuit board having:
a transmitter coil having an outer diameter; and
a two-part receiving coil positioned within the outer diameter of the transmitter coil,
wherein the housing encapsulates the flexible circuit board, the transmitter coil and the two-part receiving coil; and
a movable target formed from at least partially from a magnetic material and is spaced apart from the housing, the movable target is configured to move along a predetermined trajectory relative to the housing, the circuit board and the housing are shaped similar to the predetermined trajectory of the movable target,
wherein when the target is moved along the predetermined trajectory, the movement causes an area of low permeability in regions of the housing that is sensed by the two-part receiving coil to determine a location of the target with respect to the housing.

19. The inductive sensor assembly of claim 18, wherein the predetermined trajectory is a linear trajectory.

20. The inductive sensor assembly of claim 18, wherein the predetermined trajectory is one of an arcuate trajectory, a spirograph trajectory, and a helix trajectory.
